(19) United States
(12) Patent Application Publication
(10) Pub. No.: US 2009/0194439 A1
(43) Pub. Date: Aug. 6, 2009

(54) Bicycle chain replacement part holder

(76) Inventor: Jimmy Dean Gross, Tacoma, WA (US)

Correspondence Address: R REAMS GOODLOE, JR. & R. REAMS GOODLOE, P.S., 24722 104TH. AVENUE S.E., SUITE 102, KENT, WA, 98030-5322, US

(21) Appl. No.: 12/321,973

(22) Filed: Jan. 26, 2009

Related U.S. Application Data
(60) Provisional application No. 61/023,555, filed on Jan. 25, 2008.
(60) Provisional application No. 61/027,897, filed on Feb. 12, 2008.

(51) Int. Cl. B21L 21/00; B65D 85/00; B25B 27/22

(52) U.S. Cl. 206/231; 206/338; 59/7; 7/138; 81/487

(57) ABSTRACT

A bicycle chain replacement part holder. In an embodiment, the part holder is a generally parallelepiped shaped resilient urethane rubber block with slight notches at the corner suitable for releasably securing the part holder in an interference snap-in fit pattern with the interior perimeter walls of a part holder aperture in a chain linking tool. Alternately, the part holder may be provided for separate use in a stand alone fashion. In an embodiment, a thru hole aperture is provided in the parts holder for use with a securing device, such as a key chain, so that the parts holder can be reliably secured to a known location, especially in the event that the parts holder is not secured to and within a chain linking tool.

### RELATED INVENTIONS

This invention claims priority from U.S. Provisional Patent Application No. 61/23555, entitled Chain Hooker/Linx Set tool, filed on Jan. 25, 2008, and from U.S. Provisional Patent Application No. 61/027,897, entitled Chain Hooker/Linx Set tool, filed on Feb. 12, 2008, the disclosures of each of which are incorporated herein by this reference.

### COPYRIGHT NOTICE

A portion of the disclosure of this patent document contains material that is subject to copyright protection. The patent owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This application relates to devices for storing and transporting small repair parts for mechanical equipment, and more particularly, to devices for storing and carrying small repair parts for bicycles.

### BACKGROUND

Bicycles have long been popular. Since their invention, bicycles have been used for an increasing number of activities, ranging from recreation, to commuting, to competition. Over time, millions of bicycles and millions of bicycle users have ultimately resulted in the development and use of a myriad of specialized bicycle tools and accessories, as appropriate to fill particular needs and maintenance requirements. Since most bicycles use chains to transmit energy from the rider to the driven wheel (normally the rear wheel), a occasionally arises for the repair of a chain. While chain repairs can be accomplished while on the road by an experienced cyclist, it is necessary to have at hand both the necessary tools and the necessary parts. All too often, when a cyclist experiences a chain failure, and then looks for a chain repair link, pin, or other part, the search is fruitless, as the repair parts are either hidden in or lost from the bicyclist's equipment. Thus, there remains an as yet unmet need for a device that can safely and reliably hold needed replacement parts, such as chain repair links and chain repair pins. Additionally, there remains a yet unmet need for an improved chain linking tool that will securely hold two ends of a broken chain closely together so that repairs can be made, once the required parts have been located. Of course, it would be especially helpful of the parts holder and the chain linking tools were complementary, so that all required tools and parts could be quickly located.

### SUMMARY

I have now developed a bicycle chain replacement part holder. In an embodiment, the part holder may be provided in the form of a small somewhat parallelepiped or box shaped device using a resilient molded compound, such as urethane rubber or plastic, having suitably sized and shaped recesses therein, as receptacles for securely but releasably affixing therein chain replacement parts, including repair links and repair pins. In an embodiment, a chain repair link portion can be affixed securely either an obverse side or a reverse side of the part holder, or more preferably, chain repair link portions are provided to both sides. In an embodiment, a repair pin, or pins can be releasably secured to the part holder. In an embodiment, additional apertures are provided for attachment of the parts holder to a securing device such as a key chain, so that the parts holder may be securely affixed at a known location in the bicyclist's gear, so that it may be easily located whenever needed.

In yet a further embodiment, I have developed a chain linking tool that provides an improved structure for use in making chain repairs. In an embodiment, the linking tool may include wrenches, such as a 6 mm wrench, an 8 mm wrench, and a 10 mm wrenches. In an embodiment, the linking tool may include one or more spoke wrenches, such as a 14 gauge spoke wrench and a 5 gauge spoke wrench. In an embodiment, the linking tool may additionally include a flat head screwdriver. In an embodiment, two straight chain engaging prongs are provided, each prong also having an inner curved surface sized and shaped to snugly match a multi-link chain roller in close fitting engaugement. In an embodiment, each of the two straight prongs are sized and shaped to be inserted in the chain, by poking in-between the chain link plates and hook the inner chain roller. The two straight chain engaging prongs supply a temporary fixed link that holds a chain, near the each of the ends at a break, closely together in tension, and thus creating a slack loop or loose ends for removal or installation of damaged or broken chain components.

In an embodiment, a parts holder is provided with locating notches or detents that enable a resilient parts holder to be releasably affixed to and carried by a chain linking tool. In an embodiment, shallow notches are provided along two upper corners and along two lower corners of a resilient parts holder, for resisting movement into and out of a locking position in relation to the chain linking tool. Finally, for fun and convenience, in an embodiment a chain linking tool may be provide with an artistic design, such as a silhouette of a woman therein, or a useful tool, such as a bottle opener.

### BRIEF DESCRIPTION OF THE DRAWING

The present invention will be described by way of exemplary embodiments, using for illustration the accompanying drawing in which like reference numerals denote like elements, and in which:

FIG. 1 is a perspective view of an exemplary embodiment for a bicycle chain replacement part holder.

FIG. 2 is a side perspective view of an exemplary embodiment for a bicycle chain replacement part holder, showing the device being held between the thumb and forefinger of a user, and also showing a bicycle chain repair pin therein.

FIG. 3 is a perspective view from above the side of an exemplary embodiment for a bicycle chain replacement part holder, showing the device being held between the thumb and forefinger of a user, and also showing a bicycle chain repair pin releasably secured therein.

FIG. 4 is a perspective view from above the side of an exemplary embodiment for a bicycle chain replacement part holder, showing the device being held between the thumb and forefinger of a user, and also showing a chain repair link and a pair of bicycle chain repair pins releasably secured therein.

FIG. 5 is a front view of an exemplary embodiment for a bicycle chain replacement part holder, showing the bicycle chain repair link receiving apertures, one of the bicycle chain repair pin receiving apertures, and an aperature through the part holder for use with a securing device such as the key chain as illustrated.

FIG. 6 is a top view of the exemplary embodiment for a bicycle chain replacement part holder, showing the repair pin receiving apertures, as well as the slight notches at first and second top ends to enable the part holder to be releasably secured to a chain linking tool.

FIG. 7 is a side end view of the exemplary embodiment for a bicycle chain replacement part holder as just set forth in FIGS. 5 and 6 above, showing from a different perspective the slight notches that enable the part holder to be releasably secured to a chain linking tool.

FIG. 8A is a front side view of another embodiment for an exemplary bicycle chain replacement part holder, here configured to secure a pin on either end of the part holder.

FIG. 8B is a back side view of the embodiment for an exemplary bicycle chain replacement part holder just illustrated in FIG. 8A.

FIG. 8C is a top view of the embodiment for an exemplary bicycle chain replacement part holder as just shown in FIGS. 8A and 8B, now further illustrating the configuration that allows a replacement pin to be secured on either end of the part holder.

FIG. 8D is a side end view of the embodiment for an exemplary bicycle chain replacement part holder, as just shown in FIGS. 8A, 8B, and 8C,

FIG. 9A is a front side view of another embodiment for an exemplary bicycle chain replacement part holder, here configured to secure a master link connection.

FIG. 9B is a back side view of the embodiment for an exemplary bicycle chain replacement part holder just illustrated in FIG. 9A, here configured to secure a master link connection.

FIG. 9A is a front side view of another embodiment for an exemplary bicycle chain replacement part holder, here configured to secure a master link connection to the part holder.

FIG. 9B is a back side view of the embodiment for an exemplary bicycle chain replacement part holder just illustrated in FIG. 9A, here configured to secure a master link connection to the part holder.

FIG. 10A is a front side view of another embodiment for an exemplary bicycle chain replacement part holder, here configured to secure four chain repair pins (two on the front, and two on the back) as well as a power link repair portion on the front and on the back.

FIG. 10B is a back side view of the embodiment for an exemplary bicycle chain replacement part holder just illustrated in FIG. 10A, here configured to secure four chain repair pins (two on the front, and two on the back) as well as a power link repair portion on the front and on the back.

FIG. 11 illustrates an embodiment for a chain linking tool, and also shows how a parts holder may be inserted to an inner retaining aperature with edge wall portions sized and shaped for interfitting releasable engaugement with a parts holder as described herein.

FIG. 12 illustrates an embodiment for a chain linking tool, and also shows a parts holder inserted within and secured to the edge wall portions of an inner retaining aperature.

FIG. 13 illustrates a replacement chain pin that may be secured in the parts holder described herein.

FIG. 14 illustrates the structure of a typical bicycle chain, showing inner link plates, inner link plates, rollers, and pin locations.

FIG. 15 illustrates opposing portions of one type of bicycle chain repair link that is suitable for being securely and releasibly secured in a bicycle repair part holder as described and claimed herein.

FIG. 16 is a side view of a chain linking tool in use, holding tension in a chain near each end of the broken chain, as allows for easy manipulation of the chain for repair.

FIG. 17 is a side view of a chain linking tool in use, holding tension in a chain near each end of the broken chain, as allows for easy manipulation of the chain for repair.

The foregoing figures, being merely exemplary, contain various elements that may be present or omitted from actual designs or methods that may be implemented. Other chain repair part holders may use slightly different designs, but achieve a similar result using substantially the same structures and functional components, as may be slightly modified from those embodiments as is described herein and depicted in the drawing figures provided. An attempt has been made to draw the figures in a way that illustrates at least those elements that are significant for an understanding of the various designs and methods taught herein. However, various other designs may be utilized in order to provide a versatile bicycle chain replacement parts holder. And, it will be apparent to those skilled in the art and to which this specification is directed that certain of the embodiments described herein may be practiced utilizing only some of the described aspects. Likewise, certain of embodiments described herein may be practiced without use of all specific details set forth.

### DETAILED DESCRIPTION

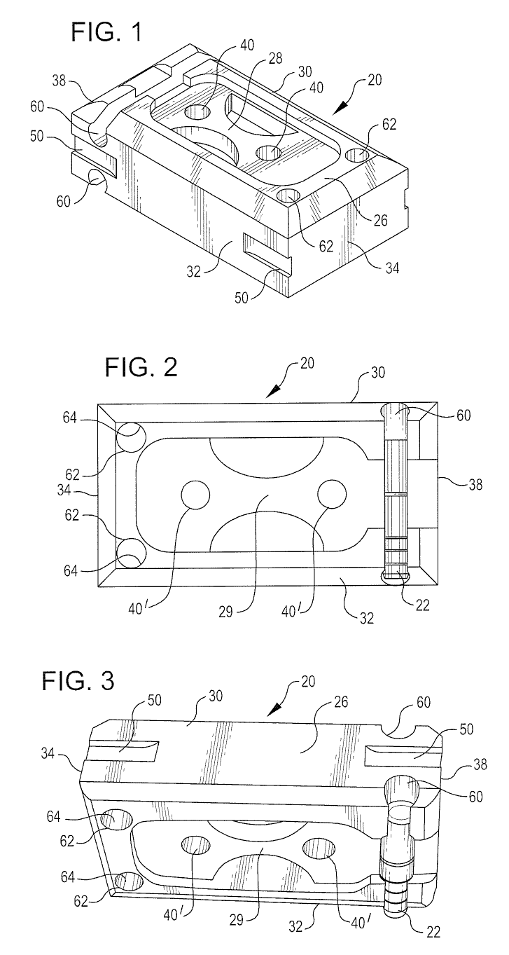

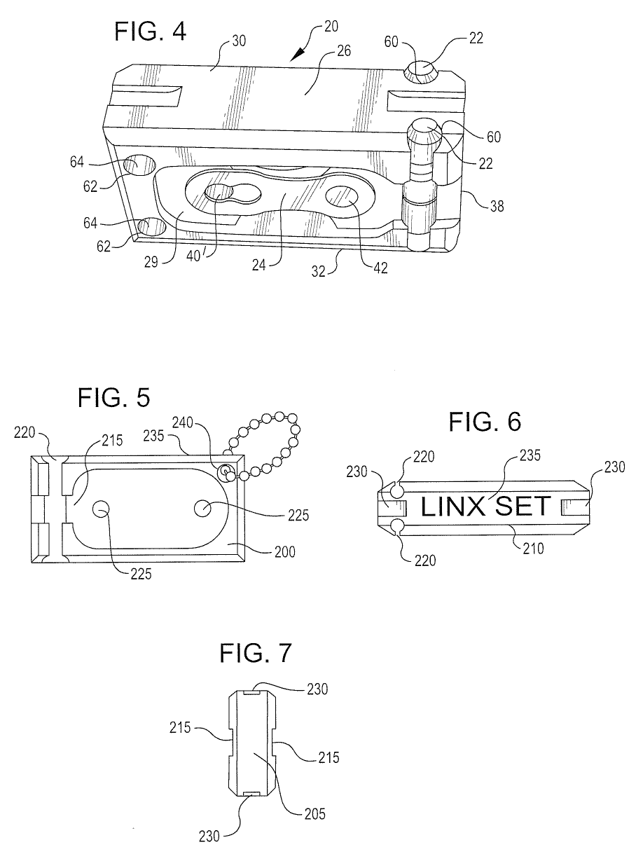

Attention is directed to FIGS. 1 through 4, where an exemplary design for a bicycle chain replacement small parts holder 20 is provided. This small parts holder 20 is designed for releasably securing replacement bicycle chain parts such as chain pins 22 (see FIGS. 2, 3, and 4) or chain repair links 24 (see FIG. 4). The small parts holder 20 may, in an embodiment, be provided having a resilient, generally parallelepiped shaped body 26. In an embodiment, the resilient body may be provided made of urethane rubber. In an embodiment the bicycle chain repair parts holder 20 may be injection molded using a 70-durometer-urethane material. Alternately, other resilient materials, such as suitable plastics, may be utilized, and the parts holder 20 may be machined or molded in other ways with suitable materials. The body 26 extends between front 28 and back 29 sides. The body 26 has upper 30 and lower 32 sides, and first 34 and second 38 ends. The body 26 has therein one or more workpiece receiving apertures 40 for receiving pin portions 42 of workpiece chain repair links 24. Also, one or more holds 44 are provided sized and shaped for detachably and securely receiving a chain pin 22.

In an embodiment as better seen in FIGS. 1 and 3, the small parts holder 20 further includes a plurality of slight notches 50 adjacent each of the first 34 and second 38 ends. In an embodiment such slight notches 50 are provided on both the upper 30 and lower 32 sides of body 26. The notches 50 are sized and shaped for providing an interference snap-in attachment to a workpiece chain linking tool 100, as further described below.

Attention is further directed to FIGS. 1 and 4, where it can be seen that the small parts holder 20 is provided wherein body 26 has a first workpiece receiving recess 52 in the front 28 side. Also, the body 26 has a second workpiece receiving recess 54 in the back side 29. Each of the workpiece receiving recesses 52 and 54 are sized and shaped to accommodate a plate portion 58 of a workpiece bicycle chain repair link 24, as noted in FIG. 4. As further seen in FIGS. 1 through 4, and later figures discussed herein below, in an embodiment, the small parts holder 20 includes in the front side 28 a pair of workpiece receiving apertures 40 for receiving pin portions 42 (or 245 as noted below) of workpiece chain repair links 24. In an embodiment, the small parts holder 20 includes, in back side 29, a pair of workpiece receiving apertures 40′ for receiving pin portions 42 of workpiece chain repair links 24. In an embodiment as seen in FIG. 2, apertures 40 and 40′ may meet via extending entirely through body 26.

Returning now to FIG. 1, it can be seen that body 26 may include one or more, or in this embodiment, at least two holds 60 that are sized and shaped for detachably and securely receiving a chain pin 22 (see FIG. 2). As easily appreciated from FIG. 1, the holds 60 may be provided as generally C-shaped resilient partial tubular members extending from the upper 30 to the lower 32 sized (top to bottom) of the body 26.

As shown in FIG. 2, the body 26 may further include one or more key chain receiving apertures 62 defined by a through wall portion 64 extending through the body 26 from the front side 28 to the back side 29.

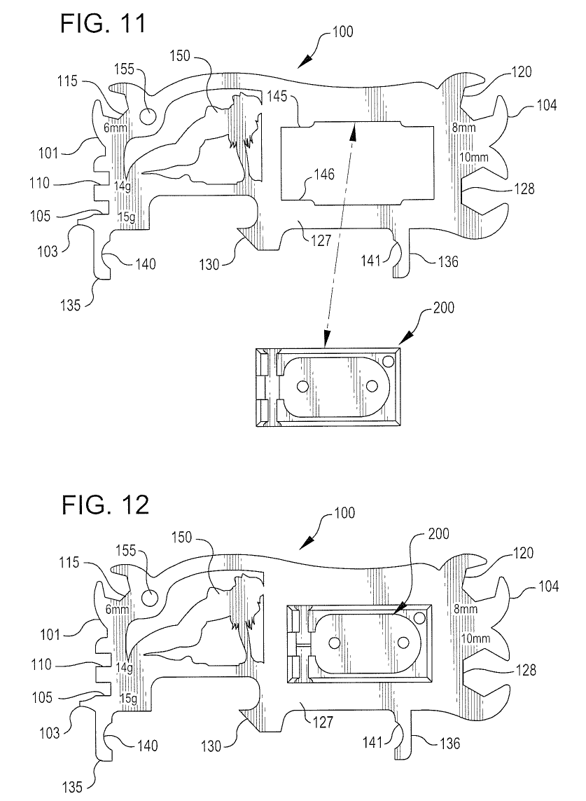

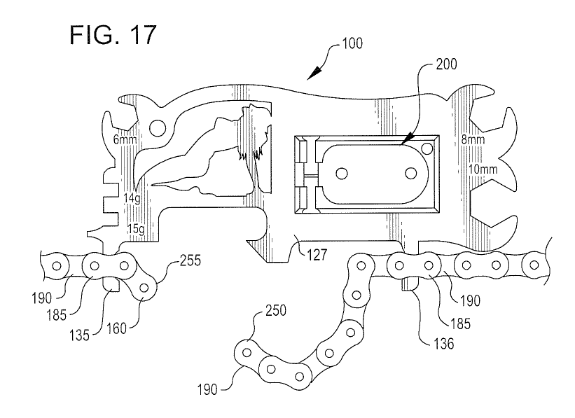

As those or ordinary skill in the art and to whom this specification is directed in a bicycle, the chain has constant tension applied by the rear derailleur. Thus, when removing or installing certain parts, such as when chain repairs must be made, the tension of the chain must to be eliminated. FIGS. 11, 12, 16, and 17 shows a novel chain linking tool 100, provided as noted herein as a multi function bicycle tool. On a first end portion 101 of the chain linking tool 100 there is a flat head screwdriver 103, a 14-gauge spoke wrench 105, a 15-gauge spoke wrench 110, and a 6 mm wrench 115. On the other or second end portion 104 is an 8 mm wrench 120, and a 10 mm wrench 125. An upper portion 126 is provided as part of body of tool 100. On the lower portion 127 is a “bottle opener” 130 and also spaced apart first 135 and second 136 downwardly projecting prongs. First prong 135 has a rearwardly projecting face 140 with an inner radius that is sized and shaped for complementary mating engagement with a roller of a multi-link chain 180. Second prong 136 has a forwardly projecting face 141 with an inner radius that is sized and shaped for complementary mating engagement with a roller 180 (see FIG. 14) of a multi-link chain 18. Prongs 135 and 136 provide an external link that holds the chain in tension while removing or installing a “Power Link” type connection 170 or a chain pin type connection 165 within the upper or lower chain run. The two prongs 135 and 136 poke in-between the outer chain link plates 185 (see FIG. 14). The prongs 135 and 136 are spaced apart a suitable distance, for example, about the same distance the length of five outer chain links 185. The chain linking tool 100 can be machined, forged or laser cut from any suitable materials. The chain linking tool may have different sized spoke wrenches, with wrenches with open or closed-ended.

When increasing the number of hooked rollers 180 between prongs 135 and 136, more slack in the chain is created, and thus there is a larger hanging bow in the chain, as can be appreciated by reference to FIG. 16. By approximately equalizing the equal number of hooked rollers 180 between the middle of prongs 136 and 136, a center link that is to be worked on will tend to stay in center between the two prongs (see FIG. 16). The chain linking tool 100 prongs 135 and 136 work with nearly all types and sizes of commonly encountered bicycle chains such as 7, 8, 9 or 10-speed bicycle chains.

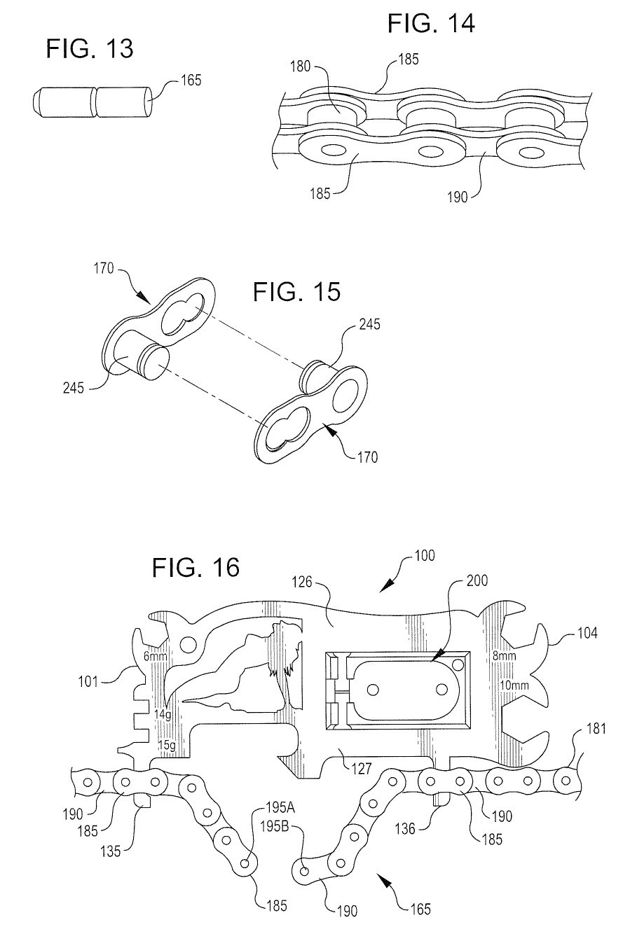

In an embodiment, the chain linking tool 100 may be provided shaped and sized to hold therein as an insert the chain parts holder 20 or 200 as otherwise described herein. As can be seen by reference to FIG. 11, a tool kit can be provided, having a replacement parts holder 20 and a chain linking tool 100. In such an embodiment, the parts holder 20 will can be provided with a notches 50 that provide an interference snap-in fit between downwardly projecting upper securing lips 146 and upwardly projecting securing lips as noted in FIG. 11. In such case, the chain linking tool 100 holes the spare parts holder 20 or 200, which in turn will provide releasably secure storage for parts, for example, spare “Power Link” type connections 170 and spare chain pins 165, or the other parts as noted above. or as seen in FIGS. 13 and 15. Also, in an embodiment, there is a hole 240 in the bicycle chain repair parts holder 200 and a hole 155 in the chain linking tool 100 that are used as an attachment point for a ball chain or split key ring, to securely affix the tool kit and/or the parts holder to a known location for retrieval when needed. In an embodiment, an artistic design, such as a silhouette of a woman 150, can be provided. Such a design may be implemented as defined by a cutout portion in body of tool 100 adjacent the artistic design.

Attention is directed to FIGS. 14, 15, and 17, which show the chain linking tool 100 set up for using the prongs 135 and 136 to install or remove a “Power Link” type connection 170 from the chain. The chain linking tool prongs 135 and 136 can be hooked to a chain and used in any selected gearing selection or gearing combinations. To use the device, the user pokes one end of the chain linking tool 100 prong 135 in-between the first outer chain link plates 185 just behind or next to the “Power Link” type connection 170 and the other prong 135 in-between the outer chain link plates 185 forward of the “Power Link” type connection 170. At this point you have a slack loop of chain that hangs down without any chain tension. The chain linking tool prongs 140 conform to the inner “Chain Roller” 180. The prongs are held in place from the tension of the rear derailleur. This allows the hooker inner roller 180 and its link plates 190 hold a stabile and stiff position 160 when removing or installing a “Power Link” type connection 170 from the chain. To remove the “Power Link” type connection 170 from the chain while using the chain linking tool prongs 135, a user can just slightly pinch the “Power Link” 170 together and push one half of the “Power Link” 170 rearward or towards the hooked inner roller 180 (see FIG. 14) or the inner link plates 190 while the other half of the “Power Link” 170 stays in a stable position, which is the case while removing or installing the “Power Link”, which parts easily. When installing the “Power Link” type connection 170 with the chain linking tool 100 a user can first poke one half of the “Power Link” 170 shaft 245 into the front outside portion 250 of the chain and the other half of the “Power link” 170 shaft 245 into the rear inside portion of the chain 255 and then slip them together. The chain linking tool prongs 135 and 136 can also be used to properly size a chain to the selected gearing combinations and derailleur type. This is done by properly inserting and hooking the chain linking tool prongs 135 to the desired chain length and removing the necessary chain links in-between the chain linking tool prongs 135 and 136 while the chain is in the largest gearing combinations.

Attention is directed to FIG. 16, which shows the chain linking tool 100 while installing or removing a chain pin 165 with the chain linking tool prongs 135. The chain linking tool prongs 135 and 136 can be used in any gearing combinations. You simply poke one end of the chain linking tool 100 prong 135 in-between the outside chain link plates 185 behind the chain pin connection 195A. You than grab and pull the front portion of the chain until you can put the chain linking tool prong 136 in-between the outside chain link plates 185 forward of the chain pin connection 195B, and then let go. You can increase or decrease the hooked spacing to create a smaller or larger slack chain loop that hangs down to work on the desired chain link. The chain linking tool prongs 140 conform to the inner “Chain Roller” 180 and are held in place from the tension of the rear derailleur. At this point there is a slack loop of chain that hangs down without any chain tension, with the chain pin 165 in the center of the slack loop of chain that hangs down and allows for the easy removal or installation of the chain pin 165 while using a “Chain Pin Repair Tool” 270.

Returning now to FIGS. 5, 6 and 7, these show the front, side, and top view for an embodiment of a bicycle chain repair parts holder 200. The parts holder is made to hold all types and sizes of the “Power Link” type connections 170 such as a 7, 8, 9 or 10-speed from well known manufacturers such as Sram, Wipperman, KMC, IRD, and Campagnolo. Other more generic names for this “Power Link” type connection 170 are called a super link, snap link, connex link, missing link or a quick release link connection. The bicycle chain repair parts holder 20 or 200 also holds spare Shimano 7, 8, 9 or 10-speed “Chain Pins” 165 or two Campagnolo chain pins for the HD 10-speed chain link kit. Other possibilities and uses abound. The bicycle chain repair parts holder 20 or 200 may also hold a BMX “Master Link” (see FIGS. 9A, 9B)

FIGS. 10A and 10B show another embodiment for a bicycle chain repair parts holder. This design is configured to hold spare Shimano 7,8,9, or 10-speed replaceable chain pins 165 or two Campagnolo brand chain pins” for the HD 10-speed chain Link Kit. Each side of the bicycle chain repair parts holder 200 will hold one chain pin 165 in the crossway slot 220 that is slightly smaller than the chain pin 165. One half of a “Power Link” type connection 170 shaft 245 inserts into the pinhole 225 that slightly smaller then the “Power Link” type connection 170 shaft 245, within a recessed area 215. On all four corners of the top and bottom side face, with the bicycle chain repair parts holder name 235 are four undercut corner slots 230. The four undercut corner slots 230 are used for the bicycle chain repair parts holder to slide and snaps into the chain linking tool tool opening 145. There is also a hole 240 that is provided in the bicycle chain repair parts holder for a “Split Key Ring” or “Ball Chain” attachment point. The bicycle chain repair parts holder may also be used separately from the chain linking tool tool as a “Key Chain” while holding your spare chain parts.

When installing or removing a Shimano brand or Campagnolo brand chain pins 165 from the bicycle chain repair parts holder you simply push them in or push and pull them out of the crossway slots 220. You may also pull one end of the chain pin 165 straight up and out of the crossway slots 220.

When installing or removing the “Power Link” type connection 170 shaft 245 from the bicycle chain repair parts holder you simply push them in or pull them out of the securing hole 225, with the receiving holes being slightly smaller then the 245 shaft. Another way to remove the “Power Link” is lightly pick up the lose end of the “Power Link” connection 170 and rotate it outwards to pull it out.

The bicycle chain repair parts holder 20 or 200 can also be made to hold a BMX “Master Link” connection. The BMX “Master Link” has two “Pin Shafts” that are connected to a “Link Plate” and used with a separate single “Link Plate” and “Snap Clip” which allows for connecting the “Master Link” together during use. The “Master Link” could then poke into one side of the bicycle chain repair parts holder with the receiving holes slightly smaller and having the same spacing as the “Master Link” shafts. The separate “Link Plate” and “Snap Clip” are then held in the other side of the bicycle chain repair parts holder under a flap or flaps, groove, pocket or even under the “Master Link” as it pokes into the bicycle chain repair parts holder.

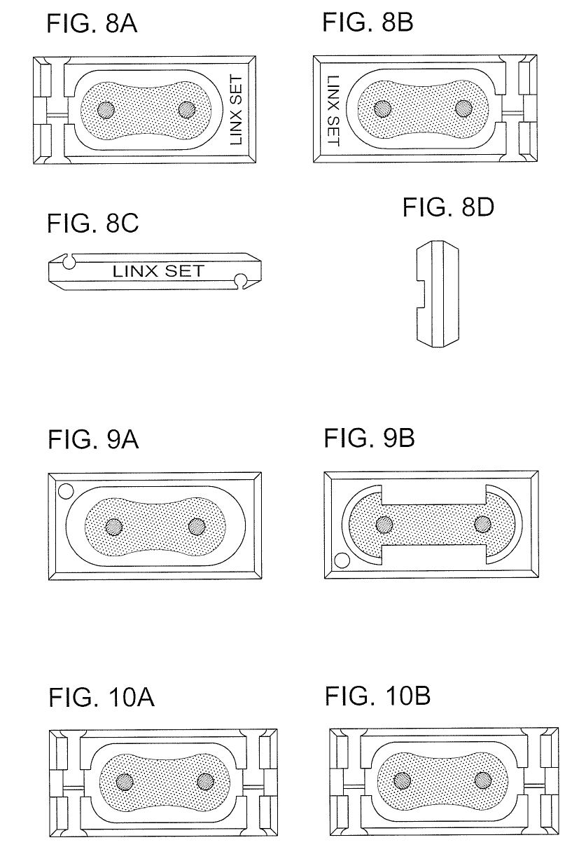

FIGS. 8A, 8B, 8C, and 8D show yet another alternative embodiment for a thinner bicycle chain repair parts holder which holds one “Power Link” type connection and two “Chain Pins” connections. Another alternative embodiment shown in FIGS. 9A and 9B is a bicycle chain repair parts holder that holds one “Master Link” type connection. The “Master Link” pokes into the receiving holes that are slightly smaller and having the same spacing as the “Master Link” shafts. The backside is where the separate “Link Plate” and “Snap Clip” are held. They can be held under a flap or flaps, in a groove, pockets, undercuts or secured under the “Master Link” once it pokes into the bicycle chain repair parts holder, however there are other possibilities.

The bicycle chain repair parts holder can have multiple 240 holes that are used as attachment points for a “Split Key Rings” or “Ball Chain”.

Thus, as explained herein, the bicycle chain repair parts holder can hold a variety of types and sizes of chain repair parts with multiple storage holds. The chain bicycle chain repair parts holder 20 Or 200 is an excellent way to hold extra chain repair parts for yourself, or for a friend in the need. The spare parts holder will eliminate the need to dig through baggage to look for spare chain parts.

In the foregoing description, for purposes of explanation, numerous details have been set forth in order to provide a thorough understanding of the disclosed exemplary embodiments for the design of a novel bicycle chain replacement part holder, and for a chain linking tool. However, certain of the described details may not be required in order to provide useful embodiments, or to practice a selected or other disclosed embodiments. Further, for descriptive purposes, various relative terms may be used. Terms that are relative only to a point of reference are not meant to be interpreted as absolute limitations, but are instead included in the foregoing description to facilitate understanding of the various aspects of the disclosed embodiments. And, various actions or activities in a method described herein may have been described as multiple discrete activities, in turn, in a manner that is most helpful in understanding the present invention. However, the order of description should not be construed as to imply that such parts or activities are necessarily order dependent. And, in different embodiments, one or more features may be provided alone or simultaneously, while other elements may be may be added. Also, the reader will note that the phrase “in an embodiment” or “in one embodiment” has been used repeatedly. This phrase generally does not refer to the same embodiment; however, it may. Finally, the terms “comprising”, “having” and “including” should be considered synonymous, unless the context dictates otherwise.

Importantly, the aspects and embodiments described and claimed herein may be modified from those shown without materially departing from the novel teachings and advantages provided by this invention, and may be embodied in other specific forms without departing from the spirit or essential characteristics thereof. Therefore, the embodiments presented herein are to be considered in all respects as illustrative and not restrictive or limiting. As such, this disclosure is intended to cover the structures described herein and not only structural equivalents thereof, but also equivalent structures. Numerous modifications and variations are possible in light of the above teachings. Therefore, the protection afforded to this invention should be limited only by the claims set forth herein, and the legal equivalents thereof.

1. A small parts holder for releasably securing replacement bicycle chain parts, comprising:
a resilient, generally parallelepiped shaped body, said body extending between front and back sides, said body having upper and lower sides, and first and second ends, said body comprising one or more workpiece receiving apertures for receiving pin portions of workpiece chain repair links, and one or more holds sized and shaped for detachably and securely receiving a chain pin.

2. The small parts holder as set forth in claim 1, wherein said upper and lower sides further comprise slight notches adjacent each of said first and said second ends, said notches adapted for interference snap-in attachment to a workpiece chain linking tool.

3. The small parts holder as set forth in claim 1, wherein said small parts holder comprises urethane rubber.

4. The small parts holder as set forth in claim 1, wherein said front side of said body comprises a first workpiece receiving recess, said first workpiece receiving recess sized and shaped to accommodate a plate portion of a workpiece bicycle chain repair link.

5. The small parts holder as set forth in claim 1, wherein said back side of said body comprises a second workpiece receiving recess, said workpiece receiving recess sized and shaped to accommodate a plate portion of a workpiece bicycle chain repair link.

6. The small parts holder as set forth in claim 1, wherein said front of said body comprises a pair of workpiece receiving apertures for receiving pin portions of workpiece chain repair links.

7. The small parts holder as set forth in claim 1, wherein said rear of said body comprises a pair of workpiece receiving apertures for receiving pin portions of workpiece chain repair links.

8. The small parts holder as set forth in claim 1, wherein said body comprises at least two holds sized and shaped for detachably and securely receiving a chain pin.

9. The small parts holder as set forth in claim 8, wherein said holds comprise generally C-shaped resilient partial tubular members extending from said upper side to said lower side of said body.

10. The small parts holder as set forth in claim 1, wherein said body further comprises one or more key chain receiving apertures defined by a through wall portion extending therethrough from said front side to said back side.

11. A bicycle tool for engaging a bicycle chain, comprising:
a body, said body comprising
an upper portion, said upper portion comprising an upper interior edge portion having one or more downwardly projecting upper securing lips extending therefrom;
a lower portion, said lower portion comprising a lower interior edge portion having one or more upwardly projecting lower securing lips extending therefrom;
said upper securing lips and said lower securing lips sized and shaped to secure therein a resilient workpiece shaped for snap-in interference fit therebetween;
a first end portion and a second end portion, said first and second end portions each extending between said upper portion and said lower portion;
spaced apart first and second downwardly projecting prongs, each of said first and second downwardly projecting prongs extending from said lower portion.

12. The tool as set forth in claim 11, wherein said first prong further comprises a rearward projecting face, said rearward projecting face sized and shaped for complementary mating engagement with a workpiece bicycle chain roller.

13. The tool as set forth in claim 11, wherein said second prong further comprises a forward projecting face, said forward projecting face sized and shaped for complementary mating engagement with a workpiece bicycle chain roller.

14. The tool as set forth in claim 11, wherein said first end portion further comprises at least one spoke wrench.

15. The tool as set forth in claim 11, wherein said first end portion further comprises a first spoke wrench of 14 gauge size, and a second spoke wrench of 15 gauge size.

16. The tool as set forth in claim 11, wherein said tool further comprises one or more open jaw wrenches of selected size.

17. The tool as set forth in claim 16, wherein said tool further comprises multiple open jaw wrenches of differing size.

18. The tool as set forth in claim 11, further comprising, between said upper portion and said lower portion, at least one artistic design at least partially defined by a cutout portion adjacent thereto.

19. The tool as set forth in claim 11, further comprising, depending from said lower portion, a hooked lip, said hooked lip sized and shaped with respect to its location below a bottle opener portion of said lower portion so as to be operable as a bottle opener.

20. A bicycle tool repair kit, comprising:
(a) a replacement parts holder,
said replacement parts holder comprising a resilient, generally parallelepiped shaped replacement parts holder, said replacement parts holder having a body between front and back sides, said body having upper and lower sides, and first and second ends, said upper and lower sides having therein slight notches adjacent each of said first and said second ends, said body comprising one or more workpiece receiving apertures for receiving workpiece chain repair links, and one or more holds for detachably and securely receiving a chain pin; and
(b) a chain linking tool,
said chain linking tool comprising a body, said body having an upper portion, said upper portion comprising an upper interior edge portion having one or more downwardly projecting upper securing lips extending therefrom;
a lower portion, said lower portion comprising a lower interior edge portion having one or more upwardly projecting lower securing lips extending therefrom;
said upper securing lips and said lower securing lips sized and shaped to secure therein said replacement parts holder via snap-in interference fit therebetween;
a first end portion and a second end portion, said first and second end portions each extending between said upper portion and said lower portion;
spaced apart first and second downwardly projecting prongs, each of said first and second downwardly projecting prongs extending from said lower portion.
